(19) United States
(12) Patent Application Publication
(10) Pub. No.: US 2012/0180580 A1
(43) Pub. Date: Jul. 19, 2012

(54) DISPOSABLE CARTRIDGE AND SAMPLE ANALYZER

(75) Inventors: Albert Hendrik Jan Immink, Eindhoven (NL); Maurice Hubertus Elisabeth Van Der Beek, Eindhoven (NL)

(73) Assignee: KONINKLIJKE PHILIPS ELECTRONICS N.V., EINDHOVEN (NL)

(21) Appl. No.: 13/496,948

(22) PCT Filed: Sep. 9, 2010
(86) PCT No.: PCT/IB10/54058

§ 371 Date: Mar. 19, 2012

(30) Foreign Application Priority Data
Sep. 21, 2009 (EP) 09305873.3

(51) Int. Cl. B01L 3/00

(52) U.S. Cl. 73/864.91

(57) ABSTRACT

Disclosed is a disposable cartridge (10) for insertion into a sample analyzer (50), the disposable cartridge comprising a housing (16) including a sample analysis unit (18) for engaging with the sample analyzer and a sample extraction unit (14) for extracting a sample from a sample collection unit (12) and transferring said sample to the sample analysis unit, the sample extraction unit being coupled to the sample analysis unit by a flexible connection (30), wherein one of the sample analysis unit and the sample extraction unit is flexibly connected to the housing. A sample analyzer (50) for receiving such a disposable cartridge (10) is also disclosed.

### FIELD OF THE INVENTION

The present invention relates to a disposable cartridge for insertion into a sample analyzer, the disposable cartridge comprising a housing including a sample analysis unit for engaging with the sample analyzer and a sample extraction unit for extracting a sample from a sample collection unit and transferring said sample to the sample analysis unit.

The present invention further relates to a sample analyzer for analyzing the sample in the sample analysis unit of such a disposable cartridge.

### BACKGROUND OF THE INVENTION

In the field of medial diagnostics, part-disposable sensor devices such as assay-based sensor devices are rapidly gaining popularity because of the prospect of being able to accurately determine the presence and concentration of a wide variety of analytes of interest in various samples such as bodily fluid samples including saliva, blood, blood serum, blood plasma, urine and so on.

To this end, a moiety comprising a detectable label such as a fluorescent or chemoluminescent probe, an enzyme for converting a calorimetric substrate or a magnetic particle is provided, which may specifically bind to a binding surface on a measuring apparatus, e.g. a sensor. The amount of moiety that binds to this binding surface is indicative of the amount of analyte of interest or target molecule present in the sample, for instance because the moiety can only bind to the binding surface via the analyte (i.e. a sandwich assay), because the moiety competes with the analyte to bind to the limited number of spaces on the binding surface (i.e. a competitive assay) or because the analyte also specifically binds to the same epitope of the moiety, thus inhibiting the binding of the moiety to the binding surface (i.e. an inhibitive assay). Further examples of known assays can for instance be found in WO 2007/060601, and other examples will be apparent to the skilled person.

Many suitable specific binding pair candidates are known per se, which are typically based on a lock-and-key type interaction between a receptor molecule and a molecule, e.g. a drug. This makes an assay-based apparatus particularly suitable to determine the presence or absence of specific proteins and other biological compounds such as DNA, RNA, hormones, metabolites, drugs and so on, or to determine the activity and function of active and catalytic biomolecules such as proteins, peptides, prions, enzymes, aptamers, ribozymes and deoxyribozymes. For instance, immunoassays are already used to determine the specific amount of specific proteins in body fluids to aid further diagnosis and treatment.

The use of such an assay-based apparatus provides promising new opportunities in the field of medical diagnostics, such as the provision of a handheld biosensor system for use in rapid medical diagnosis outside of laboratory environments such as the physician's office, hospital bedside, ambulance and patient's home. An example of such a diagnostic test of interest is the detection of cardiac troponin I (cTnI), which is a diagnostic marker for myocardial infarct.

A particularly promising apparatus for performing such a diagnostic test utilizes moieties labeled with a magnetic label for specifically binding to the binding surface (the sensor area) because the magnetic field can accelerate (attract) the magnetic labels towards the binding surface, thus accelerating the binding reaction rate between the moiety and the binding surface. After the removal of the unbound moieties, e.g. by washing or rinsing, the amount of moieties bound to the binding surface can be determined by the amount of the magnetic labels present in the vicinity of the surface of the binding surface, for instance by means of light reflection techniques.

For testing outside laboratory environments it is required that the diagnostic test is compact, robust and has as few user-aided steps as possible. Ideally the user only needs to add the sample to a disposable cartridge such as disclosed in European patent application EP 0 520 408 A2 and all reagents necessary for the diagnostic test are already present in the cartridge. Such a disposable cartridge may also comprise a sample collection unit, e.g. a saliva swab coupled to a sample analysis unit via a sample extraction unit. The sample extraction unit typically is arranged to transfer the sample from the sample collection unit to the sample analysis unit where the binding reaction involving the analyte of interest takes place.

The user subsequently inserts the disposable cartridge into a sample analyzer arranged to measure the binding reaction involving the analyte of interest. In case of a magnetic particle-based assay, such a sample analyzer may comprise a magnetic field generator to attract the magnetic beads to the reaction surface of the sample analysis unit and an optical measurement unit, which may for instance be arranged to utilize the principle of frustrated total internal reflection in the sample analysis unit for the analysis of the sample in the sample analysis unit.

The sample analysis unit and sample extraction unit may already be inserted into the sample analyzer before the sample collection unit is inserted into the sample extraction unit. In this way the analyzer is able to verify and validate the sample analysis unit. Furthermore, the transfer of sample from the sample collection unit into the sample analysis unit can be monitored and the immunoassay can be started automatically upon wetting of the reaction surface. This allows accurate control on the timing of the assay.

It will be appreciated that for an accurate analyte measurement, the orientation of the sample analysis unit in the sample analyzer must be precisely maintained during the measurement to avoid measurement artifacts caused by the unintentional displacement of the sample analysis unit with respect to the analytic measurement elements of the sample analyzer such as an optical measurement unit. This is not trivial because only a small part of the disposable cartridge is inserted into the sample analyzer such that the remaining part of the disposable cartridge outside the sample analyzer acts as a lever. This causes the forces exerted upon the connection between the portion of the disposable cartridge inserted into the sample analyzer and the sample analyzer itself to be large enough to cause the inadvertent displacement of the disposable cartridge inside the sample analyzer. Such a displacement has a detrimental effect on the accuracy of the measurement. It has been found that it is not (commercially) feasible to improve the rigidity of the connection between the sample analyzer and the inserted portion of the disposable cartridge to avoid such displacements.

### SUMMARY OF THE INVENTION

The present invention seeks to provide a disposable cartridge that when inserted into a sample analyzer, is less prone to such inadvertent displacements.

The present invention further seeks to provide a sample analyzer that upon receiving such a disposable cartridge suffers less from such inadvertent displacements.

According to a first aspect of the present invention, there is provided a disposable cartridge for insertion into a sample analyzer, the disposable cartridge comprising a housing including a sample analysis unit for engaging with the sample analyzer and a sample extraction unit for extracting a sample from a sample collection unit and transferring said sample to the sample analysis unit, the sample extraction unit being coupled to the sample analysis unit by a flexible connection, wherein one of the sample analysis unit and the sample extraction unit is flexibly connected to the housing.

The flexible coupling between the sample analysis unit and the sample extraction unit together with the flexible connection ensures that forces exerted upon the part of the disposable cartridge external to the sample analyzer when inserted therein are at least partially absorbed by the flexible coupling and the flexible connection, thus reducing the forces on the connection between the part of the disposable cartridge inserted into the sample analyzer and the sample analyzer itself.

The sample collection unit may be a separate element to be inserted into the disposable cartridge or may form a part thereof, in which case the sample collection unit is mounted in the sample extraction unit. In an embodiment, the sample collection unit comprises a porous material for collecting a bodily fluid, and wherein the sample extraction unit is arranged to compress the porous material to extract the bodily fluid from said material. For instance, the bodily fluid may be saliva, in which case the sample collection unit may be a porous swab.

In an embodiment, the sample analysis unit is flexibly connected to the housing such that the housing as a whole may be flexibly connected to the sample analysis unit.

The housing may comprise a pair of inner grooves for receiving the sample analysis unit, and wherein the sample analysis unit comprises respective portions for insertion into said grooves, wherein the width of said grooves exceeds the thickness of said portions such that said portions do not fit tightly into said grooves. This has the advantage that said portions have some degree of translational freedom inside said grooves, such that small movements of the housing are not automatically transferred to the connection between the sample analysis unit and the sample analyzer. The sample analysis unit may comprise a carrier having a substantially constant thickness, said carrier comprising said respective portions.

In an alternative embodiment, the sample analysis unit is flexibly connected to the sample extraction unit by a flexible member comprising a pair of rings separated by a flexible membrane, wherein the rings are in intimate, i.e. fluid-tight, contact with the sample extraction unit and the sample analysis unit respectively. This further improves the flexibility of the mounting of the sample analysis unit in the disposable cartridge.

In a further embodiment, the housing may comprise a mating member for engaging with a complementary mating member of the sample analyzer to improve the robustness of the connection of the disposable cartridge with the sample analyzer.

In accordance with a further aspect of the present invention, there is provided a sample analyzer for analyzing the sample in the sample analysis unit of the disposable cartridge having the mating member, wherein the sample analyzer comprising a chamber for receiving the sample analysis unit, said chamber comprising the complementary mating member.

In a preferred embodiment, the opposite mating member comprises a pair of flexibly mounted ball bearings for mating with a pair of recesses in the housing of the disposable cartridge, said ball bearings at least partially protruding into the chamber. This has the advantage that the ball bearings fixate the housing of the disposable cartridge in a well-defined position, thus guaranteeing the accuracy of the sample measurement performed by the sample analyzer. This is particularly advantageous if the sample analyzer further comprises an optical analysis unit, wherein the sample analysis unit of the disposable cartridge comprises an optically accessible window, wherein the ball bearings are arranged to align the optically accessible window with the optical analysis unit when mating with said pair of recesses.

In an embodiment, the ball bearings are spring-mounted, and wherein the sample analyzer further comprises a pair of nuts for adjusting the spring force exerted onto the respective ball bearings such that the user of the sample analyzer can adjust the amount of grip pressure between the sample analyzer and the disposable cartridge, for instance to ensure that the disposable cartridge can be released from the sample analyzer without requiring excessive force.

In a further embodiment, the sample analyzer is designed to receive a disposable cartridge having a sample analysis unit comprising a carrier having a substantially constant thickness, wherein the sample analyzer comprises a gripping member for gripping an end portion of said carrier when the disposable cartridge is fully inserted into the chamber. This further improves the security of the connection between the disposable cartridge, in particular the sample analysis unit and the sample analyzer. In a preferred embodiment, the gripping member comprises a support for supporting said end portion and a spring-loaded pressing member for pressing said end portion onto said support.

The disposable cartridge and the sample analyzer of the present invention may be combined to form a system of the present invention.

### BRIEF DESCRIPTION OF THE EMBODIMENTS

Embodiments of the invention are described in more detail and by way of non-limiting examples with reference to the accompanying drawings, wherein

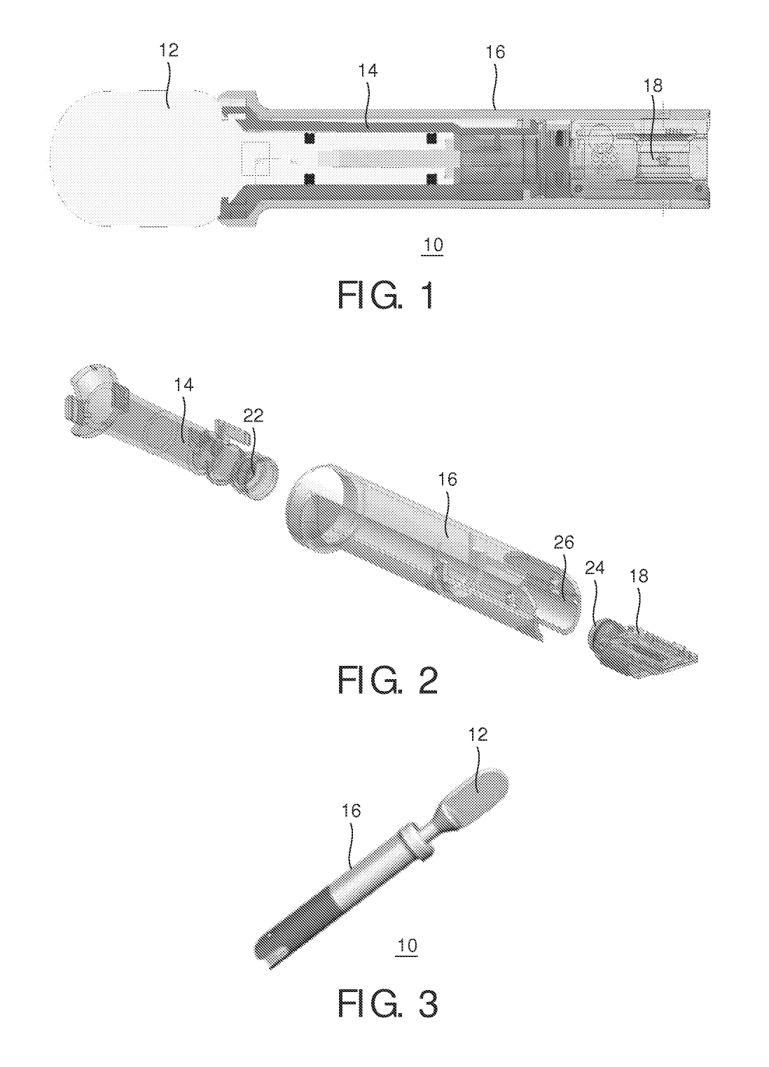

FIGS. 1 and 2 schematically depict a disposable cartridge;

FIG. 3 schematically depicts the outer design of a disposable cartridge;

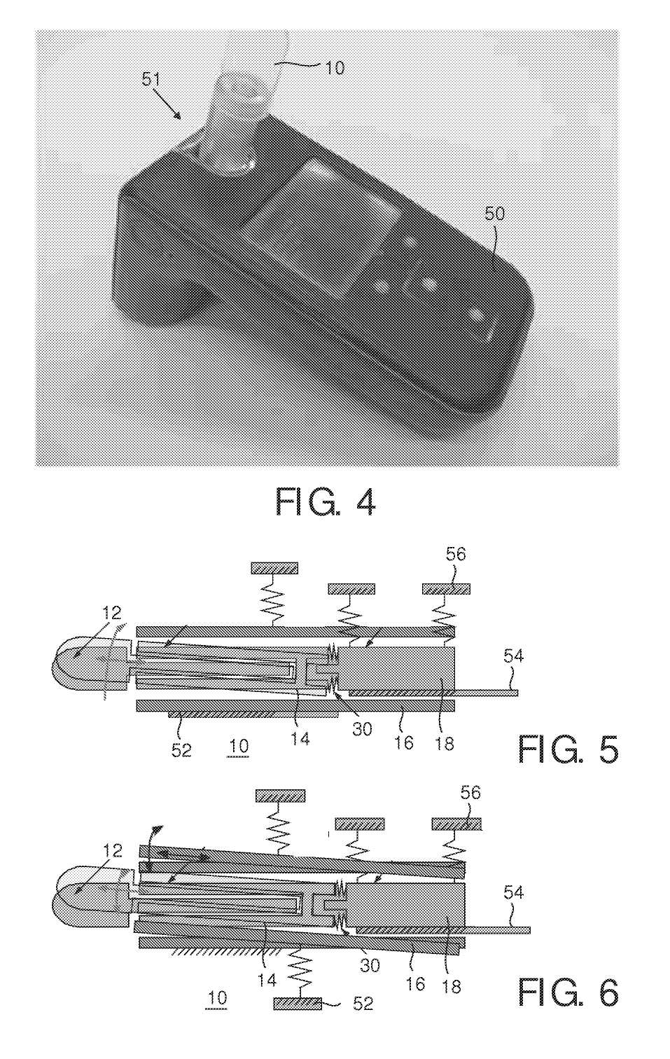

FIG. 4 schematically depicts a sample analyzer with an inserted disposable cartridge;

FIG. 5 schematically depicts a disposable cartridge in accordance with an embodiment of the present invention;

FIG. 6 schematically depicts a disposable cartridge in accordance with another embodiment of the present invention;

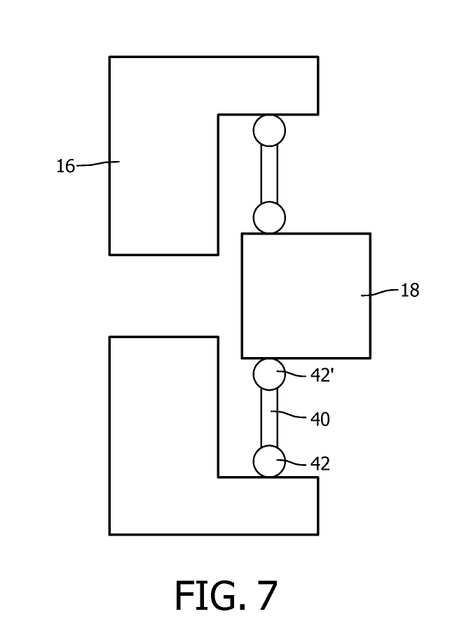

FIG. 7 schematically depicts an aspect of a disposable cartridge in accordance with yet another embodiment of the present invention;

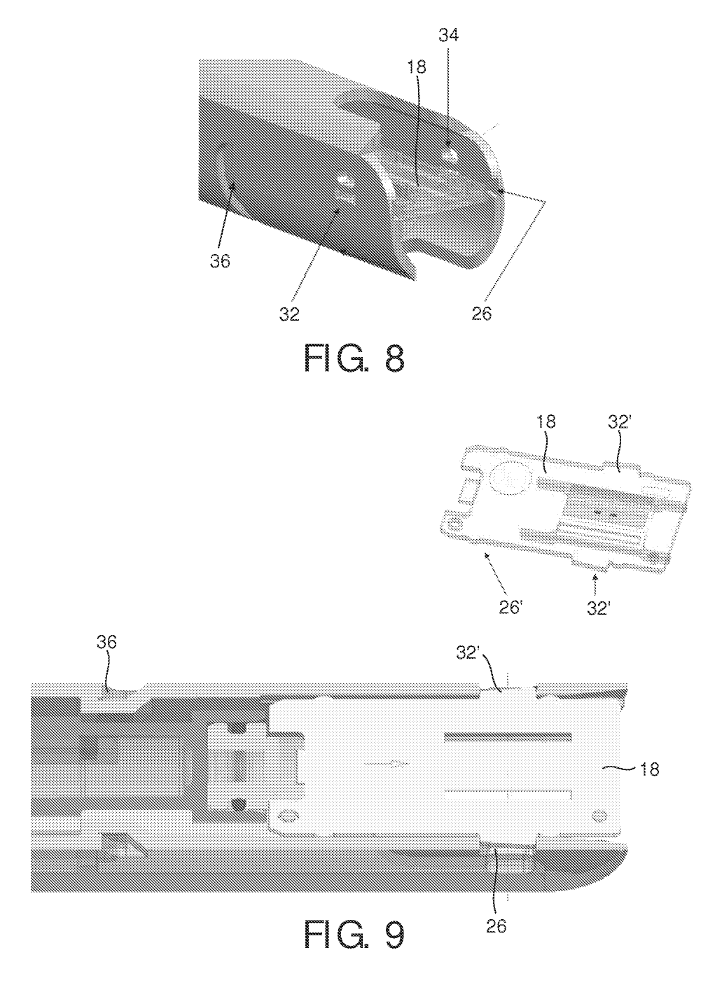

FIG. 8 schematically depicts another aspect of the disposable cartridge of FIG. 7;

FIG. 9 schematically depicts an aspect of a disposable cartridge applicable to several embodiments of the present invention;

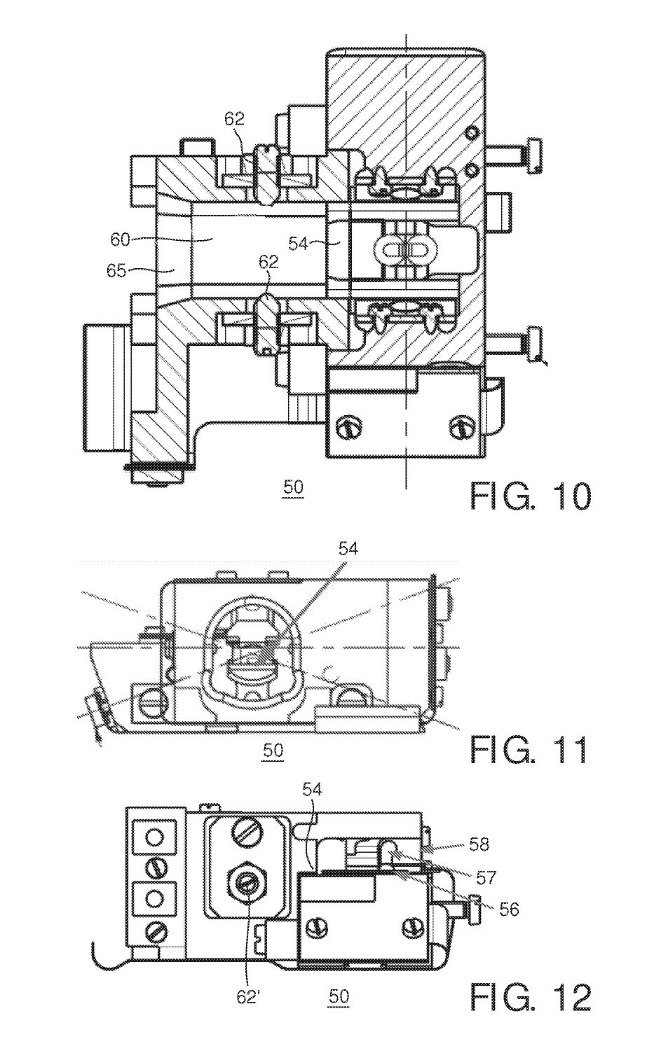

FIG. 10 schematically depicts an aspect of a sample analyzer in accordance with an embodiment of the present invention;

FIG. 11 schematically depicts an aspect of a sample analyzer in accordance with another embodiment of the present invention; and

FIG. 12 schematically depicts another aspect of the sample analyzer of FIG. 11.

### DETAILED DESCRIPTION OF THE DRAWINGS

It should be understood that the Figures are merely schematic and are not drawn to scale. It should also be understood that the same reference numerals are used throughout the Figures to indicate the same or similar parts.

FIG. 1 schematically depicts a disposable cartridge 10 for use with a sample analyzer. The disposable cartridge 10 comprises a sample collection unit 12, e.g. a saliva swab stick made of a porous material for absorbing the sample that can be squeezed for the extraction of the sample there from, a sample extraction unit 14, e.g. a squeeze unit for extracting the sample from the sample collection unit 12 and for transferring the sample to the sample analysis unit 18 by means of pressure exerted on the sample extraction unit 14. The sample analysis unit 18 may be a bio-module consisting of a fluidic and an optical part in which the pretreatment of the saliva takes place, e.g. filtering and de-bubbling, and pressure decoupling. The optical part may contain a chamber, which is filled with the sample by capillary action. In case of a sample analyzer using the internal frustrated reflection principle, the sample analysis unit 18 may further include the dry assay reagents and the dry magnetic beads.

The disposable cartridge 10 further comprises a housing 16 for integrating the sample extraction unit 14 and the sample analysis unit 18. This is shown in more detail in FIG. 2. The housing 16 comprises inner grooves 26 for receiving the sample analysis unit 18. The sample analysis unit 18 comprises a protrusion 24 for forming a fluid-tight coupling with a complementary protrusion 22 on the sample extraction unit 14. Hence, the housing 16 is used to integrate the sample extraction unit 14 and the sample analysis unit 18, and acts as a protection for these parts, as well as a mechanical interface to the sample analyzer.

In an embodiment, the sample collection unit 12 may be provided separately from the remainder of the disposable cartridge 10, i.e. may be insertable into the disposable cartridge 10. In an alternative embodiment, the sample collection unit 12 may form an integral part of the disposable cartridge 10, e.g. may be mounted in the sample extraction unit 14. For the remainder of this description, reference will be made to a separate sample collection unit 12 by way of non-limiting example only.

When performing a measurement, the sample collection unit 12 is unpacked and handed over to the person that needs to be tested. The housing 16 containing the sample analysis unit 18 and the sample extraction unit 14 is unpacked and inserted in the sample analyzer.

After inserting of the housing 16 into the sample analyzer, the disposable cartridge 10 may be optically and/or mechanically validated. This typically implies that the position of the part of the sample analysis unit 18 to be investigated with the sample analyzer is checked. This position needs to be within a certain tolerance window to ensure that the measurement results have the required accuracy. Optionally, in case of a sample analysis unit 18 being optically evaluated through an optical (transparent) surface, the integrity of the optical surface may also be checked, e.g. for scratches or stains.

After insertion of the sample collection unit 12 into the disposable cartridge 10, i.e. into the sample extraction unit 14 and subsequent extraction of the sample from the sample collection unit 12, e.g. by squeezing, the alignment of the disposable cartridge 10 in the sample analyzer is once again checked to determine if the cartridge is still within a predefined position window.

As is demonstrated in FIG. 3, the disposable cartridge 10 has a large aspect ratio, i.e. it has an elongated shape. Such a shape is typically required to ensure that the sample collection unit 12 is large enough to collect a sufficient amount of sample, e.g. saliva from the mouth, efficiently. In addition, the disposable cartridge 10 must have a sufficient length to ensure that the sample analysis unit 18 can be positioned into the sample analyzer, which may comprise one or more electromagnets for magnetic actuation of magnetic nanoparticles in the sample in the sample analysis unit 18 in case of an assay-based disposable cartridge including magnetic beads, as previously explained.

As is shown in FIG. 4, when the disposable cartridge 10 is inserted into slot 51 of the sample analyzer 50, a large part of the cartridge 10 still protrudes from the analyzer. Consequently, when the disposable cartridge 10 is mechanically actuated, e.g. touched by the hands of the operator, it is difficult to avoid movement of the disposable cartridge 10 with respect to the sample analyzer 50 due to the leverage effect of the large part of the disposable cartridge that is external to the sample analyzer 50.

This poses the following design challenge. Since the disposable cartridge 10 needs to be inserted by human force, the system design should allow for some mechanical tolerances. Nevertheless, it is very important that the sample analysis unit 18, e.g. its optical read-out window is aligned robustly with respect to the optical read-out system of the sample analyzer 50 and, if present, with respect to the electromagnets for the reasons previously discussed.

It is noted that some of the movements and misalignment can be compensated in software, e.g. the software implemented on the sample analyzer 50. Search and tracking algorithms are developed that measure the position of e.g. alignment markers on the housing 16. However, the range and bandwidth of these search and tracking algorithms is limited. Moreover, in case of a magnetic particle based assay, such algorithms are of limited use because the magnetic fields cannot be (easily) compensated in software.

In accordance with an aspect of the present invention, the disposable cartridge 10 is designed to absorb at least some of the forces exerted on the disposable cartridge 10 when inserted into the sample analyzer 50, such that the forces on the part of the disposable cartridge 10 inserted into the sample analyzer 50, i.e. the sample analysis unit 18 are reduced to such an extent that the inadvertent displacement of the sample analysis unit 18 with respect to the read-out means of the sample analyzer can be avoided.

FIG. 5 shows a first embodiment of a disposable cartridge 10 of the present invention. In the disposable cartridge 10, a fluid-tight, flexible connection 30 is provided between the sample extraction unit 14 and sample analysis unit 18, with the sample extraction unit 14 being flexibly mounted in the housing 16. FIG. 6 shows an alternative embodiment in which the fluid-tight, flexible connection 30 is provided between the sample extraction unit 14 and sample analysis unit 18, with the analysis unit 18 being flexibly mounted in the housing 16. The fluid-light flexible connection 30 may be any suitable connection, e.g. an elastomeric joint such as a rubber ring or gasket. As a result, the sample extraction unit 14 can move independently of the sample analysis unit 16 within certain design tolerances, as shown in FIGS. 5 and 6, such that any pressure exerted on the sample extraction unit 14, e.g. when extracting a sample from the sample collection unit 12, is not (fully) transferred to the sample analysis unit 18. In FIG. 5, the sample extraction unit 14 can move freely inside the housing 16 due to the fact that the sample extraction unit 14 is flexibly mounted inside the housing 16. In FIG. 6, the sample extraction unit 14 together with the housing 16 can move independently from the sample analysis unit 18 due to the fact that the sample analysis unit 18 is flexibly mounted inside the housing 16.

The flexible mounting of the sample extraction unit 14 in the housing 16 in FIG. 5 or the sample extraction unit 18 in the housing 16 in FIG. 6 does not have to be fluid-tight and may be achieved in any suitable manner, e.g. using metal springs or an elastomeric suspension.

The flexible mounting 30 between the sample extraction unit 14 and the sample analysis unit 16 shown in FIG. 5 and FIG. 6 needs to be fluid-tight. This can also be achieved using a suitable elastomeric suspension.

An example of a suitable elastomeric suspension is shown in FIG. 7. The elastomeric suspension comprises a first rubber ring 42 into which the sample analysis unit 18 is fitted and a second rubber ring 42′ mounted on the inner wall of the sample extraction unit 14. The rubber rings 42 and 42′ are spaced apart by a flexible, e.g. rubber membrane 40. As will be appreciated, the elastomeric suspension shown in FIG. 7 ensures a fluid-tight fit of the part of the disposable cartridge 10 that is suspended in the housing 16, e.g. the sample extraction unit 14 and the sample analysis unit 18.

In FIGS. 5 and 6, the disposable cartridge 10 is shown in an inserted position into the sample analyzer 50. The sample analyzer 50 may comprise engagement means to clamp or grip the inserted part of the disposable cartridge 10 to further improve the robustness of the fixation of the sample analysis unit 18 with respect to the (optical) read-out means of the sample analyzer 50. For instance, FIGS. 5 and 6 show mechanical references 52 and 54 that form a part of the sample analyzer 50. The mechanical reference 52 is designed to support the housing 16 of the disposable cartridge 10 and the mechanical reference 54 is designed to support the sample analysis unit 18 when inserted into the sample analyzer 50. This will be explained in more detail below.

FIG. 8 shows a detail of an embodiment of a disposable cartridge 10 of the present invention. In this embodiment, the sample analysis unit 18 comprises a carrier that is inserted into a pair of inner grooves 26 in the housing 16 of the disposable cartridge 10. As is shown in FIG. 9, the carrier may comprise click pads 32′ for fixating the position of the sample analysis unit 18 inside the housing 16. To this end, the housing 16 may comprise recesses 32 for receiving the click pads 32′. The carrier may further comprise protrusions 26′ for guiding the carrier in the inner grooves 26. The inner grooves 26 may be wider than the thickness of the carrier of the sample analysis unit 18 such that the sample analysis unit 18 can move freely inside the grooves 26 within the tolerances defined by the additional width of these grooves. In this embodiment, the recesses 32 should also be larger than the click pads 32′ to facilitate this limited degree of free movement of the sample analysis unit 18 inside the housing 16. It is preferable that the free movement of the sample analysis unit 18 is restricted within predefined tolerances (i.e. the grooves 26 preferably should not be omitted) because unrestricted free movement of the sample analysis unit 18 may make its placement inside the sample analyzer 50 cumbersome. This embodiment may be combined with mounting the sample analysis unit 18 inside the housing 16 using a flexible mounting member such as the aforementioned flexible suspension.

In FIG. 8, the housing 16 of the disposable cartridge 10 further comprises an evaluation window 34 for allowing evaluation of the sample analysis unit 18 by the sample analyzer 50, as well as a pair of mating members 36 (only one is shown in FIG. 8) for engaging with respective complementary mating members of the sample analyzer, e.g. ball bearings 62 (vide infra). In FIG. 8, the mating member 36 is shaped as a shallow trench in the outer surface of the housing 16 by way of non-limiting example only; it should be appreciated that other embodiments are equally feasible.

Preferably, the sample analyzer 50 is adapted to engage with the housing 16 and/or the sample analysis unit 18 to secure the fit of the disposable cartridge 10 in the sample analyzer 50 such that the risk of unwanted displacement leading to misalignment of the sample analysis unit 18 with respect to the read-out means of the sample analyzer 50 can be reduced or eliminated.

FIG. 10 shows an embodiment of the sample analyzer 50 in accordance with the present invention. The sample analyzer 50 has a chamber 60 for receiving the disposable cartridge 10. The chamber 60 has a tapered shape or a tapered inlet 65 for guiding the sample analysis unit 18 of the disposable cartridge into its intended position inside the chamber 60. The inner walls of the chamber 60 comprise a pair of mechanical references in the form of spring-loaded ball bearings 62. The respective springs push the ball bearings 62 into the chamber 60. Upon insertion of the disposable cartridge 10 into the chamber 60, the ball bearings are pushed back into the walls of the chamber 60 by the housing 16 until the ball bearings 62 meet with their respective mating members 36 in the outer surface of the housing 16. In this engagement, the ball bearings 62 click into place into the mating members 36, e.g. shallow trenches, thus fixating the housing inside the sample analyzer 50. The flexible mounting of the ball bearings 62 is chosen such that the disposable cartridge 10 can be ejected from the sample analyzer 50 without requiring excessive force, i.e. by a gentle pull, which releases the ball bearings 62 from their corresponding mating members 36 in the outer surface of the housing 16.

As shown in FIG. 10, the chamber 60 may optionally comprise a support member 54 for supporting the end portion of the sample analysis unit 18 facing the support member 54 when the disposable cartridge 10 is inserted into the sample analyzer 50. Such a support member may for instance be a flat surface for receiving the sample analysis unit 18. FIG. 11 shows a cross-section of the chamber 60 comprising the support member 54 as seen through the inlet 65. A similar support member 52 may be present for supporting the housing 16.

Upon the correct insertion of the disposable cartridge 10 into the chamber 60 of the sample analyzer 50, the sample analysis unit 18 will come to rest on the support member 54, thereby increasing the stability of the fit of the disposable cartridge 10 inside the sample analyzer 50. This fit may further be stabilized by a pressure roll pressing the sample analysis unit 18 down onto the support member 54.

This is shown in more detail in the cross-section of the sample analyzer 50 shown in FIG. 12. The pressure roll 56 is flexibly mounted by a spring 58 inside a slit 57. In rest, the pressure roll rests on the support member 54. Upon insertion of the disposable cartridge 10 into the chamber 60 as indicated by the dashed arrow, the sample analysis unit 18 is wedged in between the pressure roll 56 and the support member 54, thus pushing the pressure roll 56 into the slit 57 thereby compressing the spring 58. Consequently, the pressure roll 56 exerts pressure onto the sample analysis unit 18 through the partially compressed spring 58, thereby helping to keep the sample analysis unit fixated onto the support member 54. It will be appreciated that this embodiment is particularly suitable when the sample analysis unit 18 comprises a carrier that is thin enough to be wedged in between the pressure roll 56 and the support member 54. In an embodiment, at least the end portion of the carrier that engages with this mechanical reference has a substantially constant thickness.

Alternatively, the end portion has a decreasing thickness in the direction from the mechanical support towards the sample extraction unit 16 such that upon insertion of the end portion in between the pressure roll 56 and the support member 54, the shape of the end portion acts as a slope for the pressure roll 56, such that the pressure roll 56 is forced further upwards upon the attempted release of the disposable cartridge 10 from the chamber 60. In other words, such a tapered thickness forces the pressure roll 56 to resist release of the end portion.

FIG. 12 also shows a nut 62′ for adjusting the pressure exerted by a ball bearing 62 inside the chamber 60.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A disposable cartridge (10) for insertion into a sample analyzer (50), the disposable cartridge comprising a housing (16) including a sample analysis unit (18) for engaging with the sample analyzer and a sample extraction unit (14) for extracting a sample from a sample collection unit (12) and transferring said sample to the sample analysis unit, the sample extraction unit being coupled to the sample analysis unit by a flexible connection (30), wherein one of the sample analysis unit and the sample extraction unit is flexibly connected to the housing.

2. The disposable cartridge (10) of claim 1, further comprising the sample collection unit (12), said sample collection unit being mounted in the sample extraction unit (14).

3. The disposable cartridge (10) of claim 1, wherein the sample collection unit (12) comprises a porous material for collecting a bodily fluid, and wherein the sample extraction unit (14) is arranged to compress the porous material to extract the bodily fluid from said material.

4. The disposable cartridge (10) of claim 1, wherein the sample analysis unit (18) is flexibly connected to the housing (16).

5. The disposable cartridge (10) of claim 4, wherein the housing (16) comprises a pair of inner grooves (26) for receiving the sample analysis unit (18), and wherein the sample analysis unit comprises respective portions (26′) for insertion into said grooves, wherein the width of said grooves exceeds the thickness of said portions such that said portions do not fit tightly into said grooves.

6. The disposable cartridge (10) of claim 1, wherein the sample extraction unit (14) and the sample analysis unit (18) are connected by a flexible member comprising a pair of rings (42) separated by a flexible membrane (40), wherein the rings are in intimate contact with the housing and the sample analysis unit respectively.

7. The disposable cartridge (10) of claim 5, wherein the sample analysis unit (18) comprises a carrier having a substantially constant thickness, said carrier comprising said respective portions (26′).

8. The disposable cartridge (10) of claim 1, wherein the housing (16) comprises a mating member (36) for engaging with a complementary mating member (62) of the sample analyzer (50).

9. A sample analyzer (50) for analyzing the sample in the sample analysis unit (18) of the disposable cartridge (10) of claim 8, wherein the sample analyzer comprises a chamber (60) for receiving the sample analysis unit, said chamber comprising the complementary mating member (62).

10. The sample analyzer (50) of claim 9, wherein the complementary mating member comprises a pair of flexibly mounted ball bearings (62) for engaging with a pair of recesses (36) in the housing of the disposable cartridge, said ball bearings at least partially protruding into the chamber (60).

11. The sample analyzer (50) of claim 10, further comprising an optical analysis unit, wherein the sample analysis unit (18) of the disposable cartridge comprises (10) an optically accessible window (34), and wherein the ball bearings (62) are arranged to align the optically accessible window with the optical analysis unit when engaging with said pair of recesses (36).

12. The sample analyzer (50) of claim 10, wherein the ball bearings (62) are spring-mounted, and wherein the sample analyzer further comprises a pair of nuts (62′) for adjusting the spring force exerted onto the respective ball bearings.

13. The sample analyzer (50) of claim 10 designed for receiving a disposable cartridge (10) having sample analysis unit (18) comprising a carrier having a substantially constant thickness, the sample analyzer comprising a gripping member (52, 56) for gripping an end portion of said carrier when the disposable cartridge is fully inserted into the chamber (60).

14. The sample analyzer (50) of claim 14, wherein the gripping member comprises a support (52) for supporting said end portion and a spring-loaded pressing member (56) for pressing said end portion onto said support.

15. A system comprising a disposable cartridge (10) according to claim 1 and a sample analyzer (50) for analyzing the sample in the sample analysis unit (18) of the disposable cartridge (10), wherein the sample analyzer comprises a chamber (60) for receiving the sample analysis unit, said chamber comprising the complementary mating member (62).
